(19) United States
(12) Patent Application Publication
(10) Pub. No.: US 2002/0175911 A1
(43) Pub. Date: Nov. 28, 2002

(54) Selecting a target object in three-dimensional space

(76) Inventors: John J. Light, Beaverton, OR (US); Michael D. Smith, Hillsboro, OR (US); John D. Miller, Portland, OR (US); Sunil Kasturi, Hillsboro, OR (US)

Correspondence Address: FISH & RICHARDSON, PC, 4350 LA JOLLA VILLAGE DRIVE, SUITE 500, SAN DIEGO, CA, 92122, US

(21) Appl. No.: 09/863,046

(22) Filed: May 22, 2001

(51) Int. Cl. G06T 15/00

(52) U.S. Cl. 345/419

(57) ABSTRACT

A target object is selected in a virtual three-dimensional space by identifying objects, including the target object, in the virtual three-dimensional space, determining distances between the objects and a point in the virtual three-dimensional space, prioritizing the objects based on distances and identities of the objects, and selecting the target object from among the objects based on priority.

### TECHNICAL FIELD

This invention relates to selecting a target object in virtual three-dimensional (3D) space.

### BACKGROUND

A virtual 3D space includes objects that are either link objects or non-link objects. Non-link objects represent data, such as Microsoft® Word® documents. Link objects connect non-link objects to one another. That is, link objects represent the relationship of one non-link object to another non-link object. For example, a “table of contents” (i.e., a non-link object) may contain links to several documents referenced in the table.

### DESCRIPTION OF THE DRAWINGS

FIG. 1 is a view of a target object in virtual 3D space.

FIG. 2 is a 3D view of objects in the 3D space.

FIG. 3 is a view of a link object with an extended area.

FIG. 4 is a view of a link object with an extended area after the process of FIG. 5 is executed.

FIG. 5 is flowchart of a process for selecting a target object in 3D space.

FIG. 6 is a block diagram of a computer system on which the process of FIG. 5 may be implemented.

### DESCRIPTION

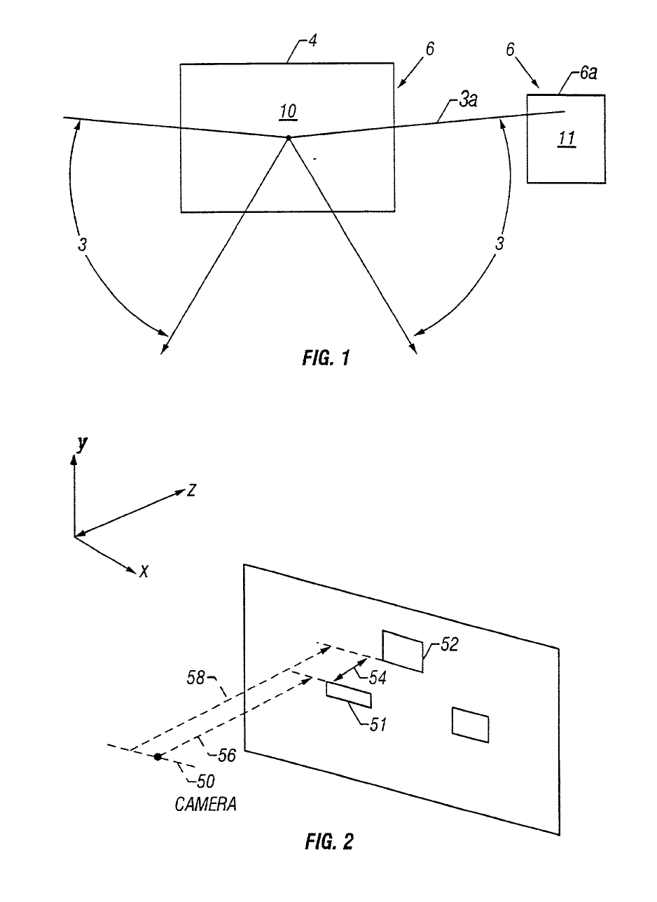

FIG. 1 shows objects in a 3D environment. The objects include non-link objects, such as objects 6, and link objects, such as objects 3. Non-link objects represent data. The data can be a computer file or any defined set of information. For example, a word processing document, a set of computer instructions, or a list of information could all be represented by non-link object 6.

A user may select a non-link object 6 in order to access data located within the non-link object or to manipulate its location and properties. The selected non-link object is referred to herein as “target object 4”. A user selects target object 4 by moving a cursor over the object in 3D space and pressing a key on a keyboard or mouse. An object may be selected for a number of reasons. For example, a user may want to change the name of the file represented by the object or to open the file. Once selected, the user has access to the file to make any necessary changes.

FIG. 1 also shows link objects 3. Link objects 3 may be depicted as lines or curves. Link objects 3 represent relationships between non-link objects 6. An association between a target object 4 and a non-link object 6a is formed by connecting a first end 10 of link object 3a to target object 4 and a second end 11 of link object 3a to non-link object 6a. For example, target object 4 may represent a directory of files on a personal computer and non-link object 6a may represent a file located within the directory. Several link objects 3 may connect to a single non-link object 6, as shown in FIG. 1.

In the virtual 3D space of FIG. 1, a link object 3 may be positioned in front of a non-link object 6. A user may want to select a link object 3 to change relationships among non-link objects 6. Link object 3 may be selected anywhere along link object 3, e.g., from end 10 to end 11.

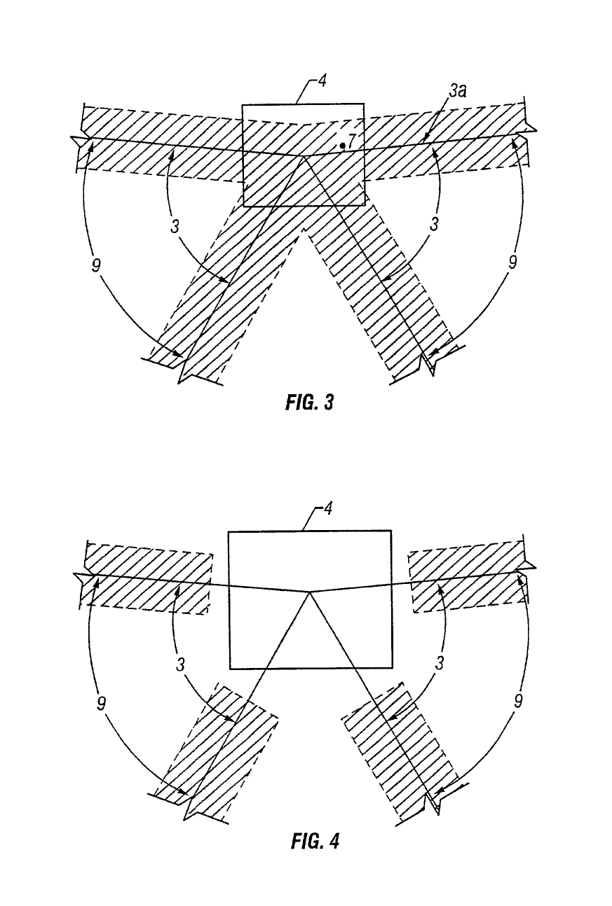

Referring to FIG. 2, a virtual camera 50 is located at an arbitrary point in the virtual 3D space. A distance (depth) 56 is measured from camera 50 to an object 51. Distance (depth) 58 is the distance between camera 50 and object 52. Distance 56 is shorter than difference 58. Accordingly, object 51 is considered closer to camera 50 than object 52 in the virtual 3D space. Generally speaking, when placing a cursor on two objects, the closer object to the camera 50 is selected. The exception to the general rule is described below.

Referring to FIG. 3, an extended area 9 represents a tolerance area for each link object. This tolerance area is generally on the order of several pixels around the link. Selecting a pixel in the tolerance area causes the corresponding link also to be selected. This can result in erroneous object selection, as explained below.

More specifically, the user does not see extended area 9, i.e., it is not displayed on screen. As shown in FIG. 3, a link object 3a can be placed in front of target object 4. Since the area from which to select target object 4 is only approximately a few pixels high and wide centered around the cursor point, extended area 9 can interfere with the selection of target object 4. Thus, a user who attempts to select target object 4 could not select target object 4. This is because extended area 9 of link object 3 is closer to camera 50 than target object 4. As a result, attempting to select target object 4, e.g., at point 7, would actually cause link 3a to be selected and not target object 4.

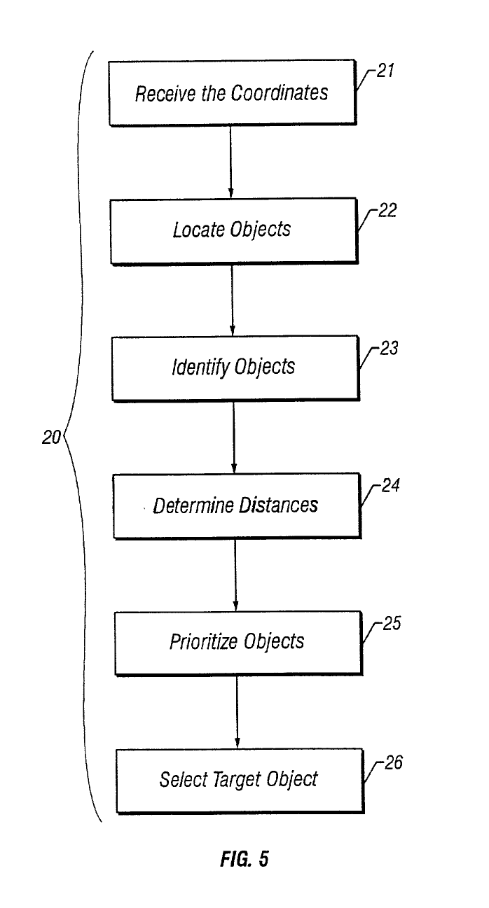

Referring to FIG. 5, a process 20 is shown for preventing extended area 9 from extending over target object 4 and obstructing a user's ability to select target object 4. Process 20 takes into account whether an object is a link object 3 or non-link object 6 during selection, as described in detail below.

Briefly, process 20 gives precedence to non-link objects that are obscured by link objects by a predetermined number of pixels in the z-direction of 3D space. The effective result of process 20 is shown in FIG. 4. That is, for all intents and purposes, the extended areas 9 over non-link object 4 are ignored, allowing the user to select target object 4 relatively easily.

In more detail, process 20 receives (21) coordinates based on user input. For example, a user may select target object 4 by pointing and clicking using a mouse. Process 20 locates (22) the objects in 3D space under the cursor at the user-selected coordinates. Because two or more objects, including the extended area, may overlap in the z-direction, more than one object may be located at the user-selected coordinates. This is because user-selection is made in the x-y plane of the computer screen. Process 20 obtains object characteristics for each selected object. Those characteristics include the position of the object and its type. The type of each object may include information such as whether an object is a non-link object or a link object. The position of each object may be the object's xyz coordinates.

Process 20 identifies (23) the selected objects by analyzing the objects' characteristics. Process 20 labels each object, including target object 4, based on whether each object is a link object or a non-link object. For example, process 20 labels link objects as link objects and non-link objects as non-link objects. Process 20 determines (24) distances between the user-selected objects and camera 50 using the positions for each object. Process 20 does this by taking the difference between coordinates of locations of the various objects. For example, referring to FIG. 2, the distance 56 between camera 50 and object 51 is the difference in the Cartesian xyz coordinate values of camera 50 and object 51.

Process 20 prioritizes (25) the objects based on the objects' distance from one another and the identities of the objects Object priorities may be stored in a list in memory and retrieved by process 20 when necessary. Generally, link objects 3 are given a lower priority than non-link objects 6. For example, a non-link object 6 and a link object 3 may have the same distance (depth) relative to camera 50. Process 20 nevertheless assigns non-link object 6 a higher priority than link object 3.

In another case, such as that shown in FIG. 3, link object 3 is actually closer to camera 50 than target object 4. In this case, process 20 gives priority to non-link object 6 only if it is less than a certain distance (depth) from link object 3 relative to camera 50. Otherwise, process 20 gives priority to link object 3. Thus, for link object 3a to be selected, for example, link object 3a must be closer to camera 50 than target object 4 by a predetermined distance.

Process 20 selects (26) target object 4 from among the objects using the stored priorities for the objects. By way of example, assume that target object 4 and link object 3a (via its extended area) are both “clicked on” by the user. Process 20 will select object 4 if (1) it is a non-link object and (2) object 4 is less than a predetermined distance (i.e., number of pixels) behind any overlapping link object 3. The distances are determined with respect to camera 50. If these two criteria are not met, process 20 will select link object 3a.

In one embodiment, an OpenGL depth buffer provides information to prioritize selection of objects. Using OpenGL, all objects under the cursor are tagged with depth information normalized between 0 and 0 xfffffff, front to back. As described above, non-link objects 6 have priority over link objects 3 up to a predetermined depth difference. In this example, for a link object 3 to be selected there must be a depth difference of less than 0x1000000 between the link and non-link objects.

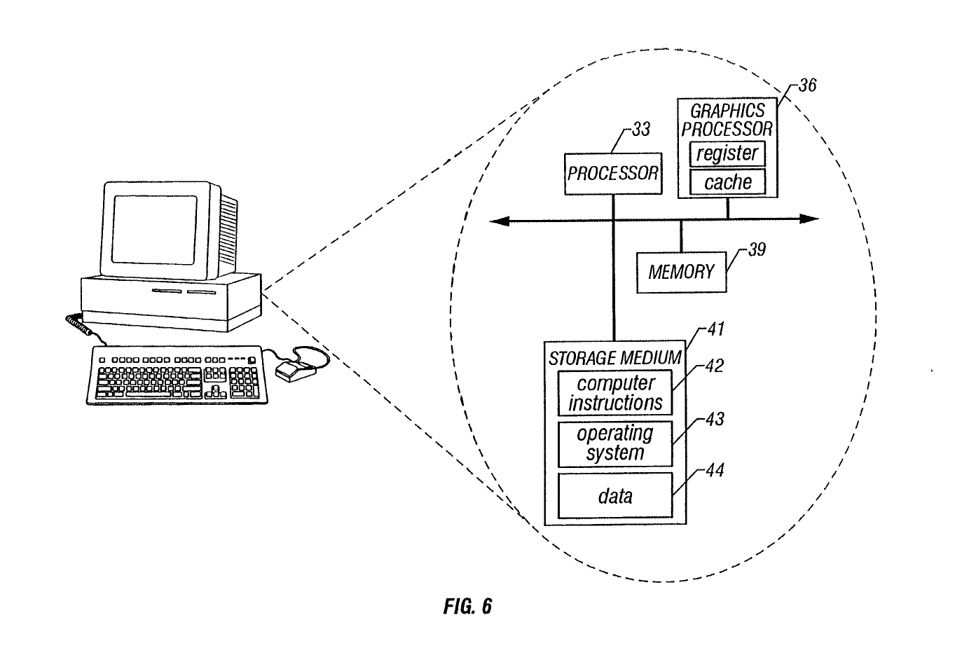

FIG. 6 shows a computer 30 for selecting a target object 4 using process 20. Computer 30 includes a processor 33, a memory 39, a storage medium 41 (e.g. hard disk), and a 3D graphics processor 41 for processing data in 3D space of FIGS. 1-4. Storage medium 41 stores the 3D data 44 which defines the 3D space, and computer instructions 42 which are executed by processor 33 out of memory 39 to select a target object using process 20.

Process 20 is not limited to use with the hardware and software of FIG. 6; it may find applicability in any computing or processing environment and with any type of machine that is capable of running a computer program. Process 20 may be implemented in hardware, software, or a combination of the two. Process 20 may be implemented in computer programs executed on programmable computers that each include a processor, a storage medium readable by the processor (including volatile and non-volatile memory and/or storage elements), at least one input device, and one or more output devices. Program code maybe applied to data entered using an input device to perform process 20 and to generate output information.

Each such program may be implemented in a high level procedural or objected-oriented programming language to communicate with a computer system. However, the programs can be implemented in assembly or machine language. The language may be a compiled or an interpreted language. Each computer program may be stored on a storage medium or device (e.g., CD-ROM, hard disk, or magnetic diskette) that is readable by a general or special purpose programmable computer for configuring and operating the computer when the storage medium or device is read by the computer to perform process 20. Process 20 may also be implemented as a computer-readable storage medium, configured with a computer program, where upon execution, instructions in the computer program cause the computer to operate in accordance with process 20.

The invention is not limited to the specific embodiments described herein. For example, the invention can prioritize non-link and link objects differently, e.g., give general priority to link objects over non-link objects. The invention can be used with objects other than non-link objects and link objects. The invention is also not limited to use in 3D space, but rather can be used in N-dimensional space (N≧3). The invention is not limited to the specific processing order of FIG. 5. Rather, the specific blocks of FIG. 5 may be re-ordered, as necessary, to achieve the results set forth above.

Other embodiments not described herein are also within the scope of the following claims.

What is claimed is:

1. A method of selecting a target object in virtual three-dimensional space, comprising:
identifying objects, including the target object, in the virtual three-dimensional space;
determining distances between the objects and a point in the virtual three-dimensional space;
prioritizing the objects based on distances and identities of the objects; and
selecting the target object from among the objects based on priority.

2. The method of claim 1, wherein the objects comprise one or more of a link object and non-link object.

3. The method of claim 2, wherein prioritizing comprises assigning a higher priority to the non-link objects than to the link objects if the distances meet a predetermined criterion.

4. The method of claim 1 wherein:
the objects include a link object; and
prioritizing comprises assigning higher priority to the link object if the link object is closer to the point than a non-link object by a predetermined distance.

5. The method of claim 4, wherein the predetermined distance comprises 0x1000000.

6. The method of claim 1, wherein identifying comprises distinguishing between a link object and a non-link object.

7. The method of claim 1, further comprising:
receiving coordinates based on a user input; and
locating the objects in the virtual three-dimensional space based on the coordinates.

8. The method of claim 1, wherein determining the distances comprises obtaining differences between coordinates in the virtual three-dimensional space for the objects and coordinates in the virtual three-dimensional space for the point.

9. An apparatus for selecting a target object in virtual three-dimensional space, comprising:
a memory that stores executable instructions; and
a processor that executes the instructions to:
identify objects, including the target object, in the virtual three-dimensional space;
determine distances between the objects and a point in the virtual three-dimensional space;
prioritize the objects based on distances and identities of the objects; and
select the target object from among the objects based on priority.

10. The apparatus of claim 10, wherein the objects comprise one or more of a link object and non-link object.

11. The apparatus of claim 9, wherein prioritizing comprises assigning a higher priority to the non-link objects than to the link objects if the distances meet a predetermined criterion.

12. The apparatus of claim 9, wherein:
the objects include a link object; and
prioritizing comprises assigning higher priority to the link object if the link object is closer to the point than a non-link object by a predetermined distance.

13. The apparatus of claim 12, wherein the predetermined distance comprises 0x1000000.

14. The apparatus of claim 9, wherein identifying comprises distinguishing between a link object and non-link object.

15. The apparatus of claim 9, wherein the processor executes instructions to:
receive coordinates based on a user input; and
locate the objects in the virtual three-dimensional space based on the coordinates.

16. The apparatus of claim 9, wherein determining the distances comprises obtaining differences between coordinates in the virtual three-dimensional space for the objects and coordinates in the virtual three dimensional space for the point.

17. An article comprising a computer-readable medium that stores executable instructions for selecting a target object in virtual three-dimensional space, the instructions causing a machine to:
identify objects, including the target object, in the virtual three-dimensional space;
determine distances between the objects and a point in the virtual three-dimensional space;
prioritize the objects based on distances and identities of the objects; and
select the target object from among the objects based on priority.

18. The article of claim 17, wherein the objects comprise one or more of a link object and non-link object.

19. The article of claim 18, wherein prioritizing comprises assigning a higher priority to the non-link objects than to the link objects if the distances meet a predetermined criterion.

20. The article of claim 17, wherein:
the objects include a link object; and
prioritizing comprises assigning higher priority to the link object if the link object is closer to the point than a non-link object by a predetermined distance.

21. The article of claim 20, wherein the predetermined distance comprises 0x1000000.

22. The article of claim 17, wherein identifying comprises distinguishing between a link object and a non-link object.

23. The article of claim 17, wherein the article further comprises instructions to:
receive coordinates based on a user input; and
locate the objects in the virtual three-dimensional space based on the coordinates.

24. The article of claim 17 wherein determining the distances comprises obtaining differences between coordinates in the virtual three-dimensional space for the objects and coordinates in the virtual three-dimensional space for the point.
